(19) United States
(12) Patent Application Publication
(10) Pub. No.: US 2002/0052939 A1
(43) Pub. Date: May 2, 2002

(54) System and method for online data recovery service

(76) Inventor: Chae-Hong Lee, Seoul (KR)

Correspondence Address: Y. Rocky Tsao, Fish & Richardson P.C., 225 Franklin Street, Boston, MA, 02110-2804, US

(21) Appl. No.: 09/779,914

(22) Filed: Feb. 8, 2001

(30) Foreign Application Priority Data
Oct. 27, 2000 (KR) 2000-63447

(51) Int. Cl. G06F 15/16; G06F 15/173

(52) U.S. Cl. 709/223; 709/218

(57) ABSTRACT

Disclosed is a method and system for an online data recovery service, in which a program server stores a program for performing either data diagnosis or data recovery of a client system, and a web server checks whether the client system having access to the online data recovery service requests data diagnosis or data recovery, the web server downloading to the client system a specific-purpose program for data diagnosis including a data diagnosis program stored in the program server when the client system requests data diagnosis, the web server downloading to the client system a specific-purpose program for data recovery including a data recovery program stored in the program server when the client system requests data recovery. Consequently, the method and system provides the client system not having a separate data diagnosis/recovery program with a specific-purpose program including the data diagnosis/recovery program as well as a password for driving the program after a defined authentication procedure by request of the program from the client system, so that the client system can gain access to data diagnosis/recovery whenever desired.

### BACKGROUND OF THE INVENTION

(a) Field of the Invention

The present invention relates to a system and method for an online data recovery service, and more specifically, to a system and method for an online data recovery service that provides a data diagnosis/recovery program by request from a client system.

(b) Description of the Related Art

In general, hard disc drives record data on a magnetic disc and are widely used as primary data storage devices in computer systems due to their high data capacity. With the recent rapid spread of personal computer systems, demand for hard discs is increasing.

Hard discs are susceptible to breakdown and missing data due to physical and electrical shocks, mistakes of the user, aging of the drive, software conflicts and the like.

As business affairs increasingly depend on computer systems with the increase in the use of personal computers, the number of data files stored in personal computers and used in execution of business affairs are increasing.

However, with the increased importance of computers in association with business affairs, there are many cases where the user makes the mistake of deleting business files or directories including the files and consequently suffers from the deletion or damage to the files.

Furthermore, when the user drives a virus vaccine program to protect the personal computer system only in consideration of viruses on the auxiliary storage such as floppy discs inserted in the computer, viruses may often invade the computer system via the Internet to damage stored data, and worse, they can make the computer system useless.

Although many methods can be used to recover the damaged data in the computer system, it is impossible to recover deleted or damaged files when the damaged data on the hard disc is fragmented.

### SUMMARY OF THE INVENTION

It is an object of the present invention to solve the problems with the prior art by providing a method for online data recovery through a program for diagnosing damage to data stored in a computer system or recovering the damaged data as an online service.

It is another object of the present invention to provide a system for performing the method for the online data recovery service.

In one aspect of the present invention, a method for an online data recovery service is provided, in which when a client system has access to the online data recovery service via an Internet backbone network to request data diagnosis or data recovery, a program for performing data diagnosis or data recovery is provided for the client system, the method including the steps of:

(a) checking whether the client system having access to the online data recovery service is authenticated, and assigning an identification (ID) to the client system according to a defined subscriber registration procedure when the client system is unauthenticated;

(b) checking whether the client system determined to be authenticated in step (a) requests data diagnosis or data recovery;

(c) downloading a specific-purpose program for data diagnosis to the client system when it is judged in step (b) that the client system requests data diagnosis;

(d) downloading a specific-purpose program for data recovery to the client system when it is judged in step (b) that the client system requests data recovery; and

(e) upon receiving a diagnosis/recovery report on results of data diagnosis or data recovery from the client system, checking details on settlement and sending a notice of settlement to the client system.

In another aspect of the present invention, there is provided a system for an online data recovery service, in which when a client system has access to the online data recovery service via an Internet backbone network to request data diagnosis or data recovery, a program for performing data diagnosis or data recovery is provided for the client system, the system including:

an authentication server including a subscriber database (DB), authenticating the client system;

a program server for storing a program for performing at least either of data diagnosis or data recovery of the client system; and

a web server for requesting the authentication server to authenticate the client system as a subscriber when the client system has access to the online data recovery service, the web server checking whether the client system requests data diagnosis or data recovery upon receiving a message indicating that the client system is authenticated as a subscriber, the web server downloading to the client system a specific-purpose program for data diagnosis including a data diagnosis program stored in the program server when the client system requests data diagnosis, the web server downloading to the client system a specific-purpose program for data recovery including a data recovery program stored in the program server when the client system requests data recovery.

The method and system for an online data recovery service provides a client system not having a separate data diagnosis/recovery program with a specific-purpose program including the data diagnosis/recovery program after a defined authentication procedure by request of the program from the client system, so that the program can be served to the client system whenever the client system requests data diagnosis or data recovery.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a diagram illustrating a system for an online data recovery service in accordance with an embodiment of the present invention;

FIG. 2 is a flow chart illustrating a method for an online data recovery service in accordance with the embodiment of the present invention;

FIG. 3 is a flow chart illustrating a method for an online data recovery service in accordance with another embodiment of the present invention; and

FIG. 4 is a flow chart illustrating the procedures subsequent to the password assignment step of FIG. 3.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

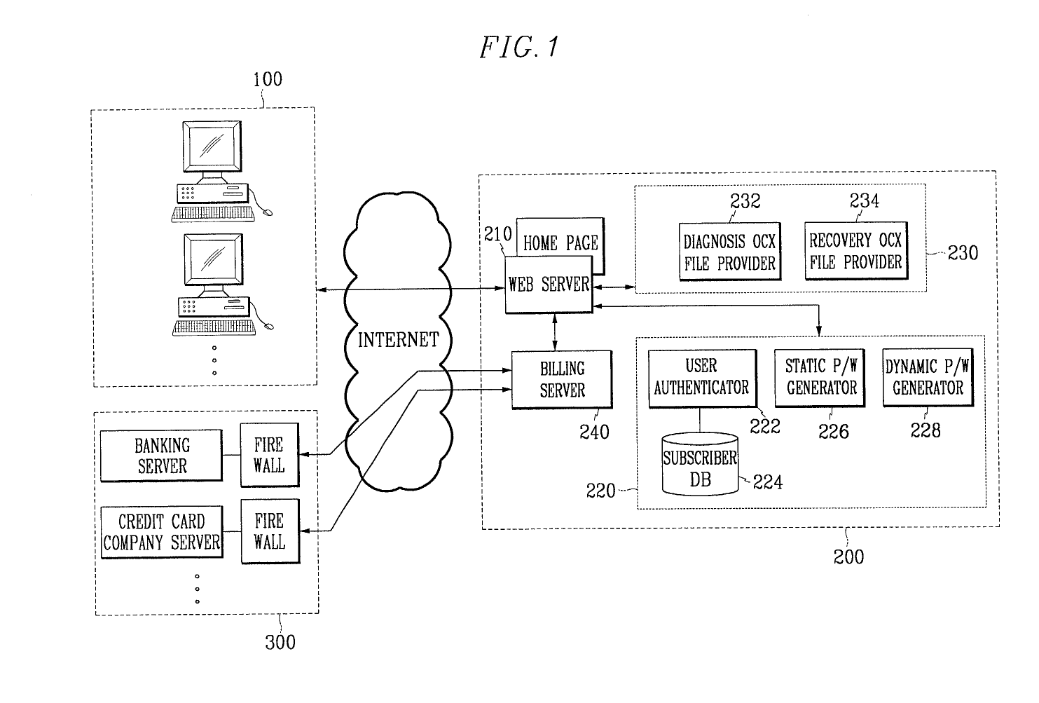

FIG. 1 is a diagram illustrating a system for an online data recovery service in accordance with an embodiment of the present invention.

Referring to FIG. 1, the system for an online data recovery service according to the embodiment of the present invention includes a client system 100, a data recovery system 200, and a banking system 300.

The client system 100 typically comprises a plurality of user computer systems capable of having access to the Internet service and the individual computer systems store a variety of programs or data on a recording medium. To check the presence of data deleted, or when the data stored in the recording media is deleted, the client system 100 has access to the data recovery system 200 to download a defined data diagnosis/recovery program.

The data recovery system 200 includes a web server 210, an authentication server 220, a program server 230, and a billing server 240, and provides a data diagnosis/recovery program for the client system 100 via the Internet backbone network upon request.

More specifically, when the client system 100 has access to the data recovery system 200 by way of the Internet backbone network, the web server 210 operating a home page entrusts the authentication server 220 with an authentication of the client system 100. If the client system 100 is authenticated, the web server 210 requests the program server 230 for a data diagnosis/recovery program and provides the client system 100 with the program.

The authentication server 220 includes a user authenticator 222, a subscriber database (DB) 224, a static password generator 226, and a dynamic password generator 228, and generates a variety of static or dynamic passwords as well as authenticates a specific client system.

More specifically, the user authenticator 222 is connected to the subscriber DB 224 and, upon request for authentication of a specific client system from the web server 210, refers to the subscriber DB 224 to inform the web server 210 of the authentication result for the client system concerned.

If the client system is authenticated, the user authenticator 222 sends the web server 210 a message indicating that the client system is a registered subscriber; otherwise, if the client system is unauthenticated, the user authenticator 222 stores subscriber information entered according to a defined subscriber registration procedure in the subscriber DB 224 and provides an identification (ID) for that client system by way of the web server 210.

The subscriber registration procedure may include not only subscriber registration for receiving a normal web service but also entry of account information or credit card information of the client for payment of the service charge in connection with the billing server.

The static password generator 226 provides the program server 230 with a first static password for driving a data diagnosis program and a second static password for driving a data recovery program.

The first and second static passwords supplied for the program server 230 are included in specific-purpose programs for data diagnosis and data recovery, respectively. The specific-purpose programs downloaded on the client system 100 drive the data diagnosis/recovery program with the stored static password according to the execution command by the user's key manipulations.

The specific-purpose programs downloaded to the client system 100 can be embodied by any one of OCX, ActiveX, DCOM (Distributed Component Object Model), COBRA, and JAVA applet. The specific-purpose programs may include a data diagnosis program for checking whether data stored in the client system or in a deleted or damaged directory are destroyed, or a data recovery program for recovering damaged data or data in a deleted or damaged directory. The specific-purpose programs may also include a function of requesting a password for driving the data diagnosis/recovery program, or an automatic download of the data recovery program in the data diagnosis program.

Particularly, the OCX referred in the embodiment of the present invention is an object-linked and included (OLE) custom control, which is a specific-purpose program made for use in an application program executed in a Microsoft Windows environment. Such an OCX provides window size control or motion control of the scroll bar.

In recent years, Microsoft has superseded the OCX file with ActiveX control, and the OCX or ActiveX control is actually embodied in the form of DLL, which is a set of small programs. DLL may be understood as a sub program to be used in numerous application programs, each of which is a container for DLL or OCX/ActiveX control objects. Visual Basic and C++ are widely used to make OCX and ActiveX.

The dynamic password generator 228 provides, via the web server 210, the client system 100 with a third dynamic password for driving a data diagnosis program by request from a diagnosis OCX file downloaded to the client system 100, and a fourth dynamic password for driving a data recovery program by request from a recovery OCX file downloaded to the client system 100.

Although the present invention has been described by way of example with the dynamic passwords being provided to the client system 100 via the web server 210, the dynamic passwords may be temporarily stored in the program server 230 in correspondence to the diagnosis/recovery OCX files and then provided to the client system 100 via the web server 210.

Namely, the dynamic password generator 228 provides the third dynamic password for driving a data diagnosis program and the fourth dynamic password for driving a data recovery program to the program server 230. The third and fourth dynamic passwords supplied to the program server 230 are separately provided to the client system 100 by request from the diagnosis and recovery OCX files, respectively.

The program server 230 comprises a diagnosis OCX file provider 232 and a recovery OCX file provider 234, and provides a diagnosis/recovery OCX file to the client system concerned by way of the web server 210 based on a control signal received from the web server 210 to provide the corresponding diagnosis/recovery OCX file to the client system.

The billing server 240 is connected via the Internet backbone network to the banking system 300 that holds an account corresponding to a specific client to demand payment for data diagnosis or recovery services. The charging time may be programmed such that the billing server 240 charges the client only after the completion of data recovery based on a recovery report sent after the client executes the data recovery operation.

Alternatively, the charging time may be programmed such that the billing server 240 charges the client based on the amount of recovered files as stated in a recovery report sent after the client executes the data recovery operation.

Expediently, the present invention has been described separately from the web server, the authentication server, the program server and the billing server in the data recovery system 200, which are divided only in a logical conception and not actually in the hardware configuration.

Hereinafter, a description will be given in detail as to the operation of the system for the online data recovery service.

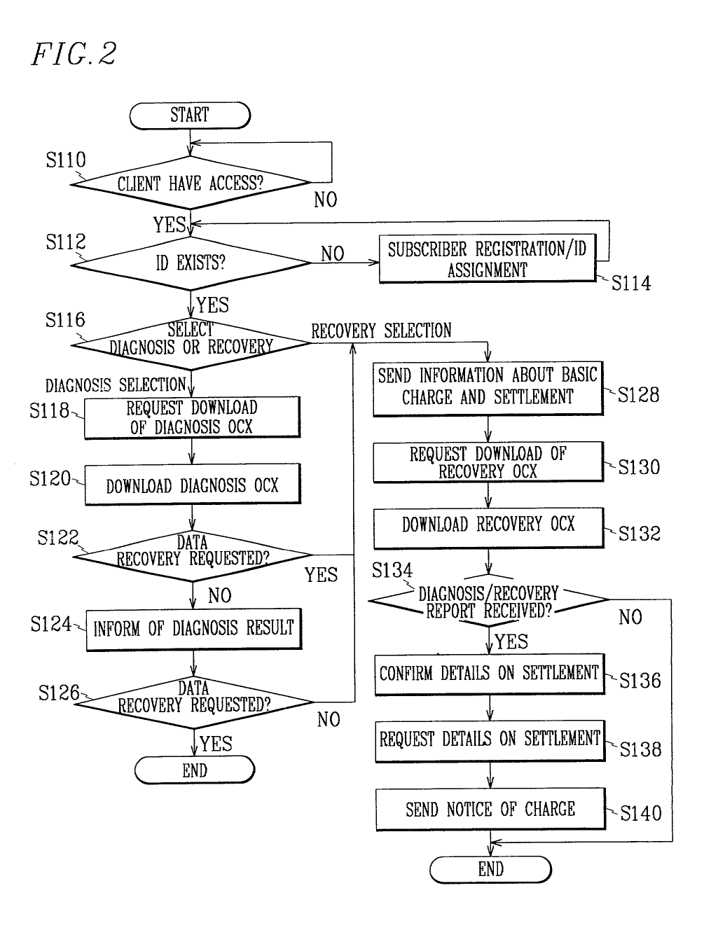

FIG. 2 is a flow chart illustrating a method for an online data recovery service in accordance with the embodiment of the present invention.

Referring to FIGS. 1 and 2, the data recovery system checks the access of the client system 100 in step S10 and, when the client system 100 has access to the online data recovery service, refers to the subscriber DB 224 for the ID of the client system 100 in step S112.

If the ID of the client system 100 does not exist in the subscriber DB 224 in step S112, the data recovery system assigns an ID to the client system 100 according to a defined subscriber registration procedure in step S114 and returns to step S112.

When the ID of the client system 100 exists in the subscriber DB 224 in step S112, the data recovery system displays blanks for marking data diagnosis and data recovery to check whether the client system 100 requests data diagnosis or data recovery, in step S116.

If the client system 100 requests data diagnosis in step S116, the web server 210 requests the program server 230 to download a diagnosis OCX file, in step S118. Then, the program server 230 downloads the diagnosis OCX file to the client system 100 via the web server 210 by request of the web server 210, in step S120. The diagnosis OCX file downloaded to the client system 100 drives a data diagnosis program through a stored static password according to the execution command of the user by key manipulations.

The diagnosis OCX file downloaded to the client system in step S120 checks in step S122 whether the client system 100 requests data recovery, and goes to step S124 by request of data recovery from the client system 100.

If the client system 100 does not request data recovery in step S122, the data recovery system sends the result of diagnosis in step S124 and checks again in step S126 whether the client system requests data recovery. If the client system 100 requests data recovery, the data recovery system goes to step S128; otherwise, it then terminates the procedure.

If the client system 100 requests data recovery in step S116, the web server 210 sends information data including basic charge and settlement to the client system 100, in step S128. When the web server 210 requests the program server 230 to download a recovery OCX file in step S130, the program server 230 downloads the recovery OCX file to the client system 100 via the web server 210, in step S132. The recovery OCX file downloaded to the client system 100 drives a data recovery program through a stored static password according to the execution command of the user by key manipulations.

Subsequently, the data recovery system checks in step S134 whether diagnosis/recovery report data are received from the client system after the completion of the data diagnosis/recovery operation. Upon receiving the diagnosis/recovery report data, the data recovery system refers to the billing server 240 for details on settlement in step S136. The web sever 210 then requests the billing server 240 to inform of details on settlement in step S138, and sends a notice of charge to the client system 100 in step 140.

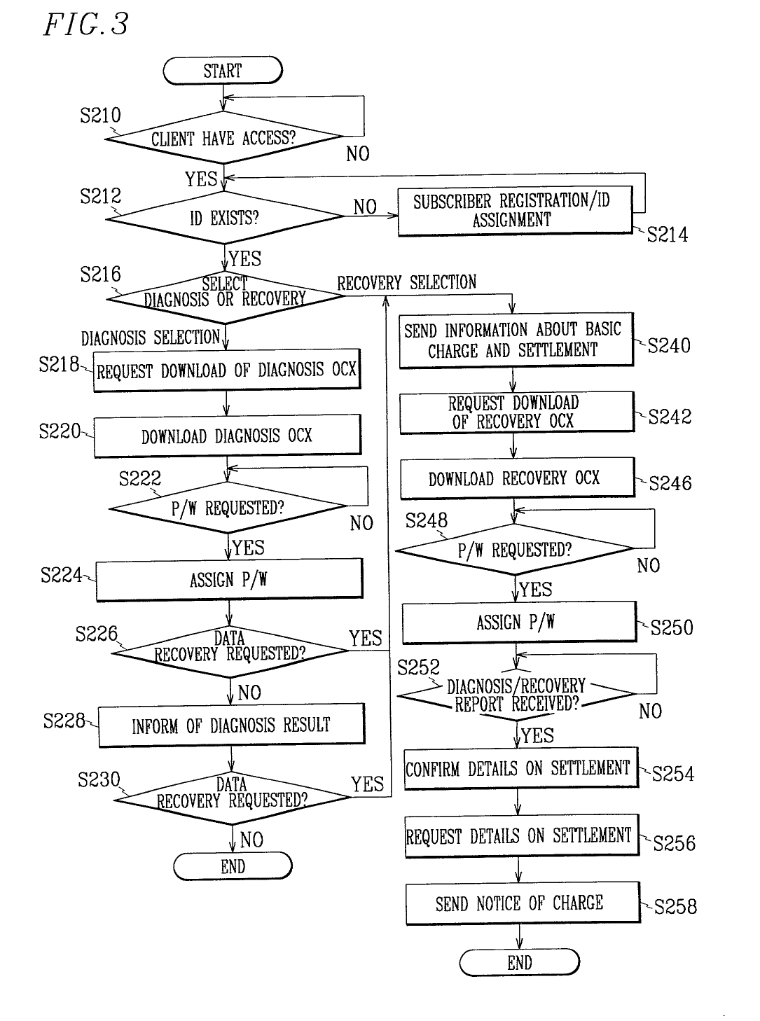

FIG. 3 is a flow chart illustrating a method for online data recovery service in accordance with another embodiment of the present invention.

Referring to FIGS. 1 and 3, the data recovery system checks the access of the client system 100 in step S210 and, when the client system 100 has access to the online data recovery service, refers to the subscriber DB 224 for the ID of the client system 100 in step S212.

If the ID of the client system 100 does not exist in the subscriber DB 224 in step S212, the data recovery system assigns an ID to the client system 100 according to a defined subscriber registration procedure in step S214 and returns to step S212.

When the ID of the client system 100 exists in the subscriber DB 224 in step S212, the data recovery system displays blanks for marking data diagnosis and data recovery in order to check whether the client system 100 requests data diagnosis or data recovery, in step S216.

If the client system 100 requests data diagnosis in step S216, the web server 210 requests the program server 230 to download a diagnosis OCX file, in step S218. Then, the program server 230 downloads the diagnosis OCX file to the client system 100 via the web server 210 by request from the web server 210, in step S220. The diagnosis OCX file downloaded to the client system 100 is not driven without a password (or dynamic password) entered even when the client gives an execution command.

Subsequently, the data recovery system checks in step S222 whether the client system 100 requests a dynamic password for driving the diagnosis OCX file, and if the dynamic password is requested, assigns the dynamic password to the client system 100, in step S224. Here, the dynamic password may be requested to the dynamic password generator 228 or assigned by OCX files previously stored in the program server 230.

Using the dynamic password assigned in the above-described way, the diagnosis OCX file downloaded to the client system drives a data diagnosis program according to the execution command of the user by key manipulations.

The data recovery system checks in step S226 whether the client system 100 requests data recovery, and sends the result of diagnosis to the client system 100 in step S228 when the client system 100 does not request data recovery. The data recovery system checks again in step S230 whether the client system 100 requests data recovery. If the client system 100 requests data recovery, the data recovery system goes to step S240; otherwise, it then terminates the procedure.

If the client system 100 requests data recovery in step S216, the web server 210 sends information data including basic charge and settlement to the client system 100, in step S240. When the web server 210 requests the program server 230 for a download of a recovery OCX file in step S242, the program server 230 downloads the recovery OCX file to the client system 100, in step S246. The recovery OCX file downloaded to the client system 100 is driven according to the execution command of the user by key manipulations. To drive the data recovery program, the OCX file is driven to request the data recovery system 200 for a defined dynamic password.

Subsequently, the web server 210 of the data recovery system 200 checks in step S248 whether the recovery OCX file requests a dynamic password for driving the data recovery program, and assigns a dynamic password by request from the recovery OCX file, in step S250. The dynamic password may be assigned by requesting the dynamic password generator 228 for the corresponding password, or by selecting a dynamic password stored in the program server 230 by OCX files.

Using the dynamic password assigned in the above-described way, the recovery OCX file downloaded to the client system 100 drives a data recovery program according to the execution command of the user by key manipulations.

The web server 210 checks in step S252 whether diagnosis/recovery report data are received from the client system 100, and upon receiving the diagnosis/recovery report data, refers to the billing server 240 for details on settlement, in step S254.

Subsequently, the web sever 210 requests the billing server 240 to inform of details on settlement in step S256, and sends a notice of charge to the client system 100 by way of an e-mail or the like in step 258.

Alternatively, if the client system 100 requests data recovery in step S226, the data recovery system provides a recovery OCX file so as to perform both data diagnosis and data recovery and sends a notice of charge for the data recovery service, in step S240.

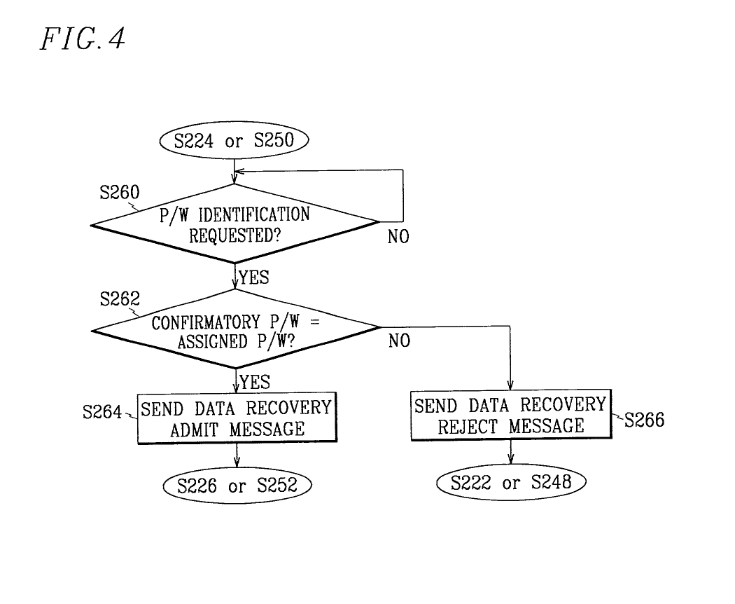

FIG. 4 is a flow chart illustrating the procedures subsequent to the password assignment step of FIG. 3.

Referring to FIGS. 1, 3 and 4, the data recovery system checks in step S260 whether the client system 100 requests identification of the dynamic password after the step S224 or 250. If the client system 100 requests the dynamic password, the data recovery system checks in step S262 whether a confirmatory password matches the assigned password. It is of course evident that back-up data for dynamic passwords are created whenever a new dynamic password is generated or assigned to the client system.

If the confirmatory password matches the assigned password in step S262, the data recovery system sends a data recovery admit message to the corresponding recovery OCX file in step S264, and goes to step S226 or S252. Upon receiving the data recovery admit message, the recovery OCX file operates in a normal way to recover the damaged data in the client system.

If the confirmatory password differs from the assigned password in step S262, the data recovery system sends a data recovery reject message to the recovery OCX file in step S266, and goes to step S222 or S248.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, when the client system has access to the online data recovery service via the Internet backbone network to request data diagnosis or data recovery, the method and system for online data recovery service provides the client system with an OCX file including a data diagnosis/recovery program as well as a defined password for driving the program, so that the client system can diagnose or recover the data stored therein without a separate data diagnosis/recovery program whenever it desires.

What is claimed is:

1. A method for an online data recovery service, in which when a client system has access to the online data recovery service via an Internet backbone network to request data diagnosis or data recovery, a program for performing data diagnosis or data recovery is provided for the client system, the method comprising the steps of:
(a) checking whether the client system having access to the online data recovery service is authenticated, and assigning an identification (ID) to the client system according to a defined subscriber registration procedure when the client system is unauthenticated;
(b) checking whether the client system determined to be authenticated in step (a) requests data diagnosis or data recovery;
(c) downloading a specific-purpose program for data diagnosis to the client system when it is judged in step (b) that the client system requests data diagnosis;
(d) downloading a specific-purpose program for data recovery to the client system when it is judged in step (b) that the client system requests data recovery; and
(e) upon receiving a diagnosis/recovery report on the results of data diagnosis or data recovery from the client system, checking details on settlement and sending a notice of settlement to the client system.

2. The method as claimed in claim 1, wherein the specific-purpose program for data diagnosis in step (c) further includes an optional function for requesting data recovery after the completion of data diagnosis for the client system and performs the step (d) when the client system requests data recovery.

3. The method as claimed in claim 1, wherein the step (d) comprises the steps of:
(d-1) sending information about basic charge and settlement; and
(d-2) requesting a download of the specific-purpose program for data recovery, and downloading the specific-purpose program for data recovery to the client system.

4. The method as claimed in claim 1, wherein the step (c) further comprises the steps of:
(c-1) checking whether a password for driving the specific-purpose program for data diagnosis is requested, after the download of the specific-purpose program for data diagnosis;
(c-2) assigning a password upon request of the password;
(c-3) checking whether data recovery is requested;
(c-4) proceeding to step (d) when data recovery is requested, and otherwise, when data recovery is not requested, checking whether a diagnosis report is received; and
(c-5) upon receiving the diagnosis report, checking details on settlement, requesting information about details on settlement, and sending a notice of charge to the client system.

5. The method as claimed in claim 1, wherein the step (d) further comprises the steps of:
(d-1) sending information including basic charge and settlement;
(d-2) requesting a download of the specific-purpose program for data recovery, and downloading the specific-purpose program for data recovery to the client system;
(d-3) checking whether a password for driving the specific-purpose program for data recovery is requested;
(d-4) assigning a password upon request of the password;
(d-5) checking whether a diagnosis/recovery report is received; and
(d-6) upon receiving the diagnosis/recovery report, checking details on settlement, requesting information about details on settlement, and sending a notice of charge to the client system.

6. The method as claimed in claim 4 or 5, after assignment of the password, further comprising the steps of:
checking whether a confirmatory password matches the assigned password, upon request of identification of the password;
providing a data recovery admit message for a data recovery program downloaded to the client system when the confirmatory password matches the assigned password; and
providing a data recovery reject message for the data recovery program downloaded to the client system when the confirmatory password differs from the assigned password.

7. The method as claimed in claim 1, wherein the specific-purpose program for data diagnosis comprises a data diagnosis program for diagnosing the presence of deleted or damaged data.

8. The method as claimed in claim 1, wherein the specific-purpose program for data diagnosis comprises:
a data diagnosis program for diagnosing the presence of deleted or damaged data; and
a password for driving the data diagnosis program.

9. The method as claimed in claim 1, wherein the specific-purpose program for data recovery comprises a data recovery program for recovering deleted or damaged data.

10. The method as claimed in claim 1, wherein the specific-purpose program for data recovery comprises:
a data recovery program for recovering deleted or damaged data; and
a password for driving the data recovery program.

11. The method as claimed in any one of claims 1 to 5, or claims 6 to 10, wherein the specific-purpose program is embodied by any one selected from OCX, ActiveX, DCOM (Distributed Component Object Model), COBRA, and JAVA applet.

12. A system for an online data recovery service, in which when a client system has access to the online data recovery service via an Internet backbone network to request data diagnosis or data recovery, a program for performing data diagnosis or data recovery is provided for the client system, the system comprising:
an authentication server including a subscriber database (DB), authenticating the client system;
a program server for storing a program for performing at least either of data diagnosis or data recovery of the client system; and
a web server for requesting the authentication server to authenticate the client system as a subscriber when the client system has access to the online data recovery service, the web server checking whether the client system requests data diagnosis or data recovery upon receiving a message indicating that the client system is authenticated as a subscriber, the web server downloading to the client system a specific-purpose program for data diagnosis including a data diagnosis program stored in the program server when the client system requests data diagnosis, the web server downloading to the client system a specific-purpose program for data recovery including a data recovery program stored in the program server when the client system requests data recovery.

13. The system as claimed in claim 12, wherein the authentication server further comprises a static password generator for providing the program server with a first static password for driving the data diagnosis program and a second static password for driving the data recovery program, the first and second static passwords being included in the specific-purpose programs for data diagnosis and data recovery, respectively.

14. The system as claimed in claim 12, wherein the authentication server further comprises a dynamic password generator for providing the client system, via the web server, with a third dynamic password for driving the data diagnosis program by request of the specific-purpose program for data diagnosis downloaded to the client system, and a fourth dynamic password for driving the data recovery program by request of the specific-purpose program for data recovery downloaded to the client system.

15. The system as claimed in claim 12, further comprising a billing server connected to a banking server by way of the Internet backbone network for charging the client system for a data diagnosis or data recovery operation.

16. The system as claimed in claim 15, wherein the billing server charges the client system only after the completion of data recovery based on a report on the result of data recovery received from the client system after the data recovery operation.

17. The system as claimed in claim 15, wherein the billing server charges the client system according to the amount of recovered files as stated in a report on the result of data recovery received from the client system after the data recovery operation.

18. The system as claimed in any one of claims 12 to 14, wherein the specific-purpose program is embodied by any one selected from OCX, ActiveX, DCOM (Distributed Component Object Model), COBRA, and JAVA applet.
